(19) United States
(12) Patent Application Publication
(10) Pub. No.: US 2013/0258222 A1
(43) Pub. Date: Oct. 3, 2013

(54) Liquid Crystal Display Device

(71) Applicant: LG DISPLAY CO., LTD., Seoul (KR)

(72) Inventor: Do Yeon Kim, Busan (KR)

(73) Assignee: LG DISPLAY CO., LTD., Seoul (KR)

(21) Appl. No.: 13/791,635

(22) Filed: Mar. 8, 2013

(30) Foreign Application Priority Data
Mar. 29, 2012 (KR) 10-2012-0032144

(51) Int. Cl. G02F 1/1343

(52) U.S. Cl. CPC G02F 1/13439
USPC 349/33

(57) ABSTRACT

Disclosed is an LCD device. The LCD device includes first and second substrates facing each other, a liquid crystal layer formed between the first and second substrates, and first and second electrodes formed on the second substrate, and generating an electric field for adjusting alignment of liquid crystal of the liquid crystal layer. The liquid crystal layer is formed by combination of a positive liquid crystal whose dielectric anisotropy (Δε)O has a positive (+) value and a negative liquid crystal whose dielectric anisotropy (Δε) has a negative (−) value.

### CROSS-REFERENCE TO RELATED APPLICATION

This application claims the benefit of the Korean Patent Application No. 10-2012-0032144 filed on Mar. 29, 2012, which is hereby incorporated by reference as if fully set forth herein.

### BACKGROUND

1. Field of the invention

The present invention relates to a liquid crystal display (LCD) device, and more particularly, to an LCD device in which pixel electrodes and common electrodes are formed on the same substrate.

2. Discussion of the Related Art

Generally, since LCD devices are driven with a low operating voltage, the LCD devices have low power consumption and are used as portable devices. Accordingly, the LCD devices are widely applied to various fields such as notebook computers, monitors, spacecrafts, airplanes, etc.

LCD devices include a lower substrate, an upper substrate,and a liquid crystal layer formed therebetween. In the LCD devices, the alignment of liquid crystal in the liquid crystal layer is adjusted with an electric field, and thus, light transmittance of the LCD devices is adjusted, thereby displaying an image.

LCD devices are variously developed in a twisted nematic (TN) mode, a vertical alignment (VA) mode, an in-plane switching (IPS) mode, or a fringe field switching (FPS) mode depending on a scheme of adjusting the alignment of liquid crystal.

Among the modes, the IPS mode and the FFS mode are modes in which a plurality of pixel electrodes and common electrodes are arranged on a lower substrate, and thus, the alignment of liquid crystal is adjusted with electric fields between the pixel electrodes and the common electrodes.

The IPS mode is a mode in which a plurality of pixel electrodes and common electrodes are alternately arranged in parallel, and thus, lateral electric fields are respectively generated between the pixel electrodes and the common electrodes, thereby adjusting the alignment of liquid crystal. The FFS mode is a mode in which a pixel electrode and a common electrode is formed to be separated from each other with an insulating layer therebetween, one electrode of the pixel electrode and common electrode is formed in a plate shape, and the other electrode is formed in a finger shape, thereby adjusting the alignment of liquid crystal with fringe fields generated between the pixel electrode and the common electrode.

Hereinafter, a related art FFS-mode LCD device will be described with reference to FIG. 1.

FIG. 1 is a sectional view schematically illustrating the related art FFS-mode LCD device.

As seen in FIG. 1, the related art FFS-mode LCD device includes an upper substrate 10, a lower substrate 20, and a liquid crystal layer 30.

Although not shown, a light blocking layer for preventing light from being leaked to an area other than a pixel area and a color filter layer for realizing colors are formed on the upper substrate 10.

An array layer 22, a pixel electrode 24, an insulating layer 26, and a common electrode 28 are formed on the lower substrate 20.

The array layer 22, although not specifically shown, includes a gate line, a data line, and a thin film transistor (TFT).

The pixel electrode 24 is formed on the array layer 22, and electrically connected to the TFT of the array layer 22.

The insulating layer 26 is formed between the pixel electrode 24 and the common electrode 28, and insulates the two electrodes 24 and 28.

The common electrode 28 is formed in a finger shape on the insulating layer 26. The common electrode 28 and the pixel electrode 24 generate a fringe field.

The liquid crystal layer 30 is formed between the upper substrate 10 and the lower substrate 20. The alignment of liquid crystal in the liquid crystal layer 30 is adjusted to the direction (see an arrow) of an electric field generated between the pixel electrode 24 and the common electrode 28.

The related art FFS-mode LCD device has the following limitations.

The related art FFS-mode LCD device uses a positive liquid crystal as liquid crystal of the liquid crystal layer 30. The positive liquid crystal is liquid crystal whose dielectric anisotropy (Δε=ε//−ε⊥) has a positive (+) value, and has a characteristic of directors of the liquid crystal being aligned in parallel to an electric field.

Therefore, as illustrated in FIG. 1, when an electric field is generated in an electric field direction (illustrated by arrows) between the pixel electrode 24 and the common electrode 28, directors of a liquid crystal 30a aligned in a central region of each arrow are aligned in parallel to a horizontal surface of the substrate, and directors of a liquid crystal 30b aligned in both end regions of each arrow are aligned to be tilted at a certain angle with respect to the horizontal surface of the substrate.

As described above, when the directors of the liquid crystal 30b are aligned to be tilted at a certain angle with respect to the horizontal surface of the substrate, a light transmittance is reduced in a corresponding region.

### SUMMARY

Accordingly, the present invention is directed to provide an LCD device that substantially obviates one or more problems due to limitations and disadvantages of the related prior art.

An aspect of the present invention is directed to provide an LCD device that can prevent a reduction of a light transmittance caused by the tilt of directors of liquid crystal.

Additional advantages and features of the invention will be set forth in part in the description which follows and in part will become apparent to those having ordinary skill in the art upon examination of the following or may he learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided an LCD device including: first and second substrates facing each other; a liquid crystal layer formed between the first and second substrates; and first and second electrodes formed on the second substrate, and generating an electric field for adjusting alignment of liquid crystal of the liquid crystal layer, wherein the liquid crystal layer is formed by combination of a positive liquid crystal whose dielectric anisotropy (Δε) has a positive (+) value and a negative liquid crystal whose dielectric anisotropy (Δε) has a negative (−) value.

In one embodiment, there is provided an LCD device including: first and second substrates facing each other; a liquid crystal layer formed between the first and second substrates; and first and second electrodes formed on the second substrate, and generating an electric field for adjusting alignment of liquid crystal of the liquid crystal layer, wherein the liquid crystal layer is formed by combination of a first liquid crystal and a second liquid crystal, wherein the director of the first liquid crystal is tilted and the director of the second liquid crystal is not tilted at a certain angle with respect to a horizontal surface of a substrate when the electric field is applied thereto.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a sectional view schematically illustrating a related art FFS-mode LCD device.

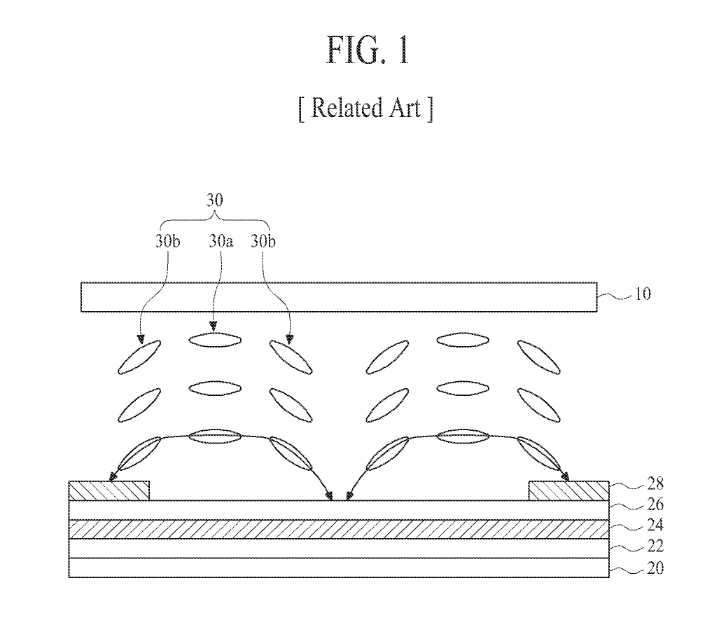

FIG. 2 is a sectional view schematically illustrating an LCD device according to one embodiment.

FIG. 3 is a graph showing changes in luminance and a driving voltage with respect to changes in positive liquid crystal content and negative liquid crystal content according to one embodiment.

FIG. 4 is a table showing changes in luminance and the driving voltage with respect to changes in an overall average vertical permittivity (ε⊥) and average horizontal permittivity (Δ//) of an liquid crystal layer while the overall average dielectric anisotropy (Δε) of the liquid crystal layer is set not to be changed, according to one embodiment.

FIGS. 5A and 5B are sectional views schematically illustrating an LCD device according to various embodiments.

### DETAILED DESCRIPTION OF THE INVENTION

In description of embodiments of the present invention, when a structure is described as being formed on or under the other structure, this description should be construed as including a case where the structures contact each other and a case where a third structure is disposed therebetween.

Hereinafter, embodiments of the present invention will be described in detail with reference to the accompanying drawings.

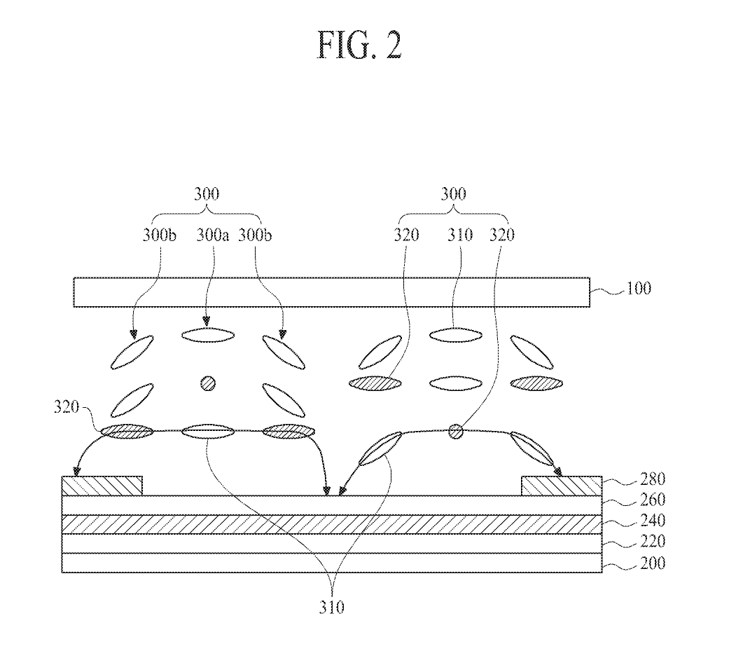

FIG. 2 is a sectional view schematically illustrating an LCD device according to an embodiment of the present invention, and relates to an FFS-mode LCD device.

As seen in FIG. 2, the LCD device according to one embodiment includes a first substrate 100, a second substrate 200, and a liquid crystal layer 300,

Although not shown, a light blocking layer, a color filter layer, an overcoat layer, and a column spacer may be formed on the first substrate 100.

The light blocking layer prevents light from being leaked to an area other than a pixel area, and may be formed in a matrix structure. The color filter layer may include a plurality of red (R), green (G), and blue (B) color filters formed in respective gaps of the light blocking layer. The overcoat layer planarizes the substrate, and may be formed on the color filter layer. The column spacer maintains a cell gap, and may be formed on the overcoat layer.

A structure of the first substrate 100 may be changed to various structures known to those skilled in the art.

The second substrate 200 faces the first substrate 100. An array layer 220, a first electrode 240, an insulating layer 260, and a second electrode 280 are formed on the second substrate 200.

The array layer 220, although not specifically shown, may include a plurality of gate lines, a plurality of data lines, and a plurality of TFTs.

The gate lines and the data lines intersect each other to define a plurality of pixel areas. Each of the TFTs is connected to a corresponding gate line and data line, and formed in a corresponding pixel area. Each TFT may include a gate electrode connected to a corresponding gate line, a semiconductor layer acting as an electron transfer channel, a source electrode connected to the data line, a drain electrode facing the source electrode, and a passivation layer protecting the source electrode and the drain electrode. Each TFT may be formed in a bottom gate structure in which the gate electrode is disposed under the semiconductor layer, or a top gate structure in which the gate electrode is disposed on the semiconductor layer.

A structure of the array layer 220 may be changed to various structures known to those skilled in the art.

The first electrode 240 is formed on the array layer 220. The first electrode 240 is formed in a pixel area to have a plate structure. The first electrode 240 may be a pixel electrode connected to the TFT of the array layer 220.

The insulating layer 260 is formed between the first and second electrodes 240 and 280, and insulates the first and second electrodes 240 and 280. The insulating layer 260 may be formed of an inorganic insulator such as silicon nitride or silicon oxide, but is not limited thereto. As another example, the insulating layer 260 may be formed of an organic insulator such as an acrylic-based polymer, or may be a double-layer structure of an inorganic insulator and an organic insulator.

The second electrode 280 is formed on the insulating layer 260. The second electrode 280 may be formed in a finger shape that includes at least one slit in a pixel area. The second electrode 280 may be a common electrode.

As described above, the first and second electrodes 240 and 280 may be the pixel electrode and the common electrode, respectively, but are not limited thereto. As another example, the first electrode 240 may be the common electrode, and the second electrode 280 may be the pixel electrode.

The first and second electrodes 240 and 280 may be formed of a transparent conductive material, but are not limited thereto.

The liquid crystal layer 300 is formed between the first and second substrates 100 and 200, and thus, liquid crystal of the liquid crystal layer 300 is adjusted by a direction of an electric field generated by the first and second electrodes 240 and 280.

The liquid crystal layer 300 is formed by a combination of positive liquid crystals, such as positive liquid crystal 310, and negative liquid crystals, such as negative liquid crystal 320.

The positive liquid crystal 310 is liquid crystal whose dielectric anisotropy (Δε=ε//−ε⊥) has a positive (+) value. That is, the positive liquid crystal 310 is liquid crystal in which a horizontal permittivity (a is greater than a vertical permittivity (ε⊥).

The negative liquid crystal 320 is liquid crystal whose dielectric anisotropy (Δε=ε//−ε⊥) has a negative (−) value. That is, the negative liquid crystal 320 is liquid crystal in which a horizontal permittivity (ε//) is less than a vertical permittivity (ε⊥).

The positive liquid crystal 310 has the characteristic that its director is aligned in parallel to an electric field direction. The negative liquid crystal 320 director is aligned perpendicularly to the electric field direction.

As described above, the liquid crystal layer 300 is formed by the combination of the positive liquid crystals 310 and the negative liquid crystals 320. Therefore, the number of liquid crystal molecules having directors tilted at a certain angle with respect to a horizontal surface of a substrate when an electric field is applied thereto is reduced, thus enhancing a light transmittance compared to the related art.

As illustrated in FIG. 2, an electric field is applied in an electric field direction (illustrated by arrows) between the first and second electrodes 240 and 280. At this point, for a liquid crystal 300a disposed in a central region of each arrow, the director of the positive liquid crystal 310 as well as the director of the negative liquid crystal 320 are aligned in parallel to the horizontal surface of the substrate. That is, when an electric field is applied, the negative liquid crystal 320 maintains the initial alignment state, and the positive liquid crystal 310 is rotated by approximate 90 degrees from the initial alignment state to the electric field direction, in which the director of the positive liquid crystal 310 and the director of the negative liquid crystal 320 are aligned in parallel to the horizontal surface of the substrate.

On the other hand, in a liquid crystal 300b disposed in both end regions of each arrow, the director of the positive liquid crystal 310 is aligned to be tilted at a certain angle with respect to the horizontalsurface of the substrate, but the director of the negative liquid crystal 320 is not tilted. Accordingly, for a liquid crystal 300b disposed in both end regions of each arrow, the number of liquid crystal molecules whose directors are tilted is reduced, thus increasing a light transmittance compared to the related art.

To enhance light transmittance,the percentage of negative liquid crystals 320 may increase overall in the liquid crystal layer 300.

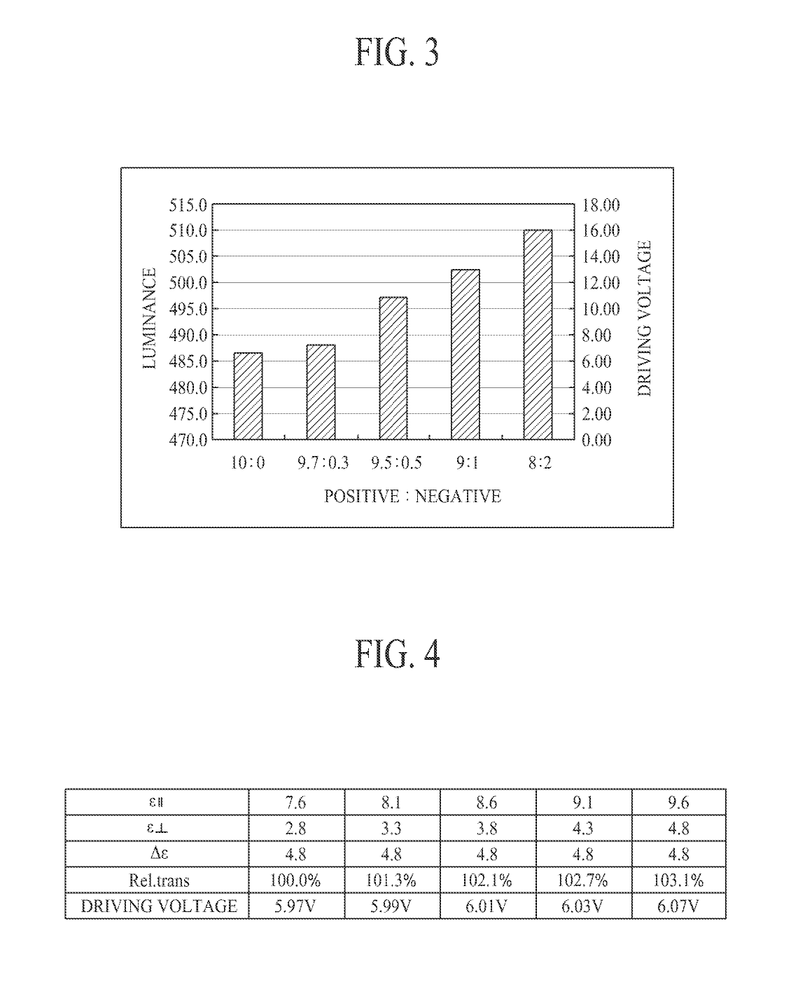

FIG. 3 is a graph showing the changes in luminance and a driving voltage with respect to the changes in the ratio between positive liquid crystals and negative liquid crystals in the liquid crystal layer 300.

As shown in FIG. 3, a liquid crystal layer in which a negative liquid crystal is added to a positive liquid crystal has greater luminance than liquid crystal layer containing only the positive liquid crystal. Particularly, it can be seen that luminance is enhanced when a negative liquid crystal content is 5 weight % or more.

Accordingly, the negative liquid crystal 320 may overall occupy 5 weight % or more of the liquid crystal layer 300.

As described above, when the liquid crystal layer 300 is formed by a combination of the positive liquid crystal 310 and the negative liquid crystal 320, the overall average dielectric anisotropy (Δε) of the liquid crystal layer 300 decreases, and thus, a driving voltage for liquid crystal can increase compared to a case in which the liquid crystal layer 300 includes only the positive liquid crystal 310.

That is, referring to FIG. 3, it can be seen that a driving voltage for liquid crystal layer in which the negative liquid crystal is added to the positive liquid crystal increases compared to liquid crystal layer including only the positive liquid crystal,

Therefore, the liquid crystal layer 300 may be designed such that the overall average dielectric anisotropy of the liquid crystal layer 300 is not reduced while the liquid crystal layer 300 is formed by combination of the positive liquid crystal 310 and the negative liquid crystal 320. To this end, the dielectric anisotropy (Δε) of the positive liquid crystal 310 may increase to compensate for a decrease in the overall average dielectric anisotropy (Δε) of the liquid crystal layer 300 caused by addition of the negative liquid crystal 320.

Accordingly, liquid crystal that has a high polarity and thus a high dielectric anisotropy (Δε) may be used as the positive liquid crystal 310. The dielectric anisotropy (Δε) is a value of a vertical permittivity (ε⊥) subtracted from horizontal permittivity (ε//). Thus, to obtain the positive liquid crystal 310 having high dielectric anisotropy, the vertical permittivity (ε⊥) is decreased or the horizontal permittivity (ε//) is increased. Considering the current technology level, it is easier to increase the horizontal permittivity (ε//).

As described above, by adding the negative liquid crystal 320, light transmittance can be increased. However, since the driving voltage can also increase when the negative liquid crystal 320 is added, the content of the negative liquid crystal 320 may be set to less than a certain range.

For example, the negative liquid crystal 320 may overall occupy 50 weight % or less of the liquid crystal layer 300, but is not limited thereto. As another example, by using the negative liquid crystal 320 having relatively high dielectric anisotropy (Δε) (i.e., to enable a value close to 0) and/or the positive liquid crystal 320 having relatively high dielectric anisotropy (Δε), the content of the negative liquid crystal 320 may overall exceed 50 weight % of the liquid crystal layer 300. However, considering the current technology level for producing the liquid crystal, the negative liquid crystal 320 may overall occupy weight 50% or less of the liquid crystal layer 300.

A compound expressed as the following Formula 1 or 2 may be used as the positive liquid crystal 310 that has a relatively high polarity and thus has high dielectric anisotropy (Δε), but is not limited thereto.

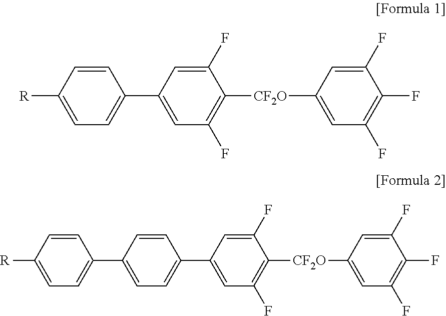

Although a compound expressed as the following Formula 3 according to the present invention has a relatively low polarity and thus has relatively low dielectric anisotropy (Δε) compared to the compounds expressed as Formulas 1 and 2, the compound expressed as the following Formula 3 may also he used as the positive liquid crystal 310.

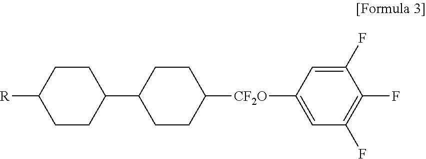

In Formulas 1 to 3, R is hydrogen, an alkyl group, an alkenyl group, or an alkoxy group.

Compounds expressed as the following Formulas 4 to 6 may be used as the negative liquid crystal 320 applicable to the present invention, but are not limited thereto.

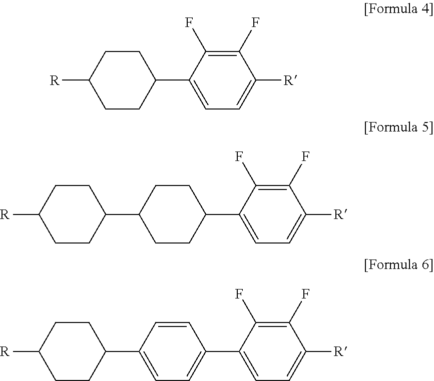

In each of Formulas 4-6, each of R and R is hydrogen, an alkyl group, an alkenyl group, or an alkoxy group.

In one embodiment, to prevent the driving voltage for liquid crystal from increasing, the overall average dielectric anisotropy (Δε) of the liquid crystal 300 formed by combination of the positive liquid crystal 310 and negative liquid crystal 320 may be greater than 2 and less than 20.

Here, the dielectric anisotropy (Δε) is a value, which is measured using an electrical signal having a frequency of I kHz at a temperature of 20° C. Hereinafter, in the specification, dielectric anisotropy, a vertical permittivity, or a horizontal permittivity is a value which is measured in the same condition.

For example, when the overall average dielectric anisotropy (Δε) of the liquid crystal layer 300 is equal to or less than 2, the driving voltage for liquid crystal can increase, causing an increase in consumption power. When the overall average dielectric anisotropy (Δε) of the liquid crystal layer 300 is equal to or greater than 20, the effect of the negative liquid crystal 320 is slightly shown, and thus, it may be unable to increase a light transmittance.

As a result, by adding the negative liquid crystal 320 into the liquid crystal 300, the present invention increases the overall average vertical permittivi (Δ⊥) of the liquid crystal layer 300, thus increasing light transmittance. Also, to prevent power consumption from increasing due to an increase in the overall average vertical permittivity (ε⊥) of the liquid crystal layer 300, the present invention increases the overall average horizontal permittivity (ε//) of the liquid crystal layer 300, thus preventing the overall dielectric anisotropy (Δε) of the liquid crystal layer 300 from decreasing.

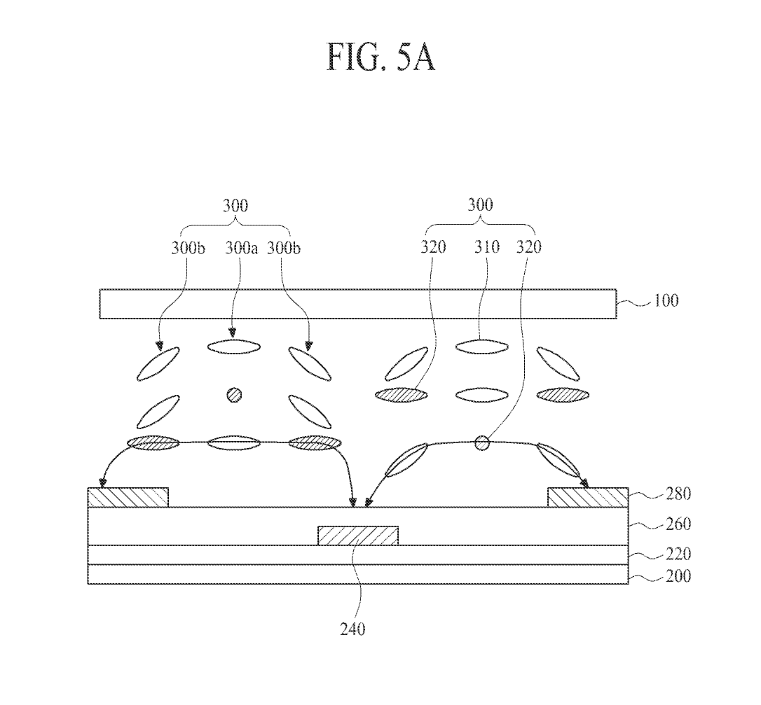

FIG. 4 is a table showing the changes in luminance and the driving voltage with respect to the changes in an overall average vertical permittivity (ε⊥) and average horizontal permittivity (ε//) of a liquid crystal layer, such as the liquid crystal layer 300, while the overall average dielectric anisotropy (Δε) of the liquid crystal layer is set not to be changed.

As shown in FIG. 4, it can he seen that a light transmittance increases as the overall average vertical permittivity (ε⊥) of the liquid crystal layer 300 increases. Also, it can be seen that the driving voltage increases as the overall average vertical permittivity (ε⊥) of the liquid crystal layer 300 increases, but the increase is less than the increase in the light transmittance.

As a result, it can be seen that when the overall average vertical permittivity (ε⊥) of the liquid crystal layer 300 increases and simultaneously the overall average horizontal permittivity (ε//) of the liquid crystal layer 300 increases, a light transmittance increases, and moreover, an increase in the driving voltage is minimized.

Considering the above-described conditions, the content of the negative liquid crystal 320 and the content of the positive liquid crystal 310 may in one embodiment be designed such that the overall average vertical permittivity (Δ⊥) of the liquid crystal layer 300 becomes not less than 3 and not more than 8.

For example, when the overall average vertical permittivity (ε⊥) of the liquid crystal layer 300 is less than 3, the effect of the negative liquid crystal 320 is slightly shown, and thus, a light transmittance can decrease. When the overall average vertical permittivity (ε⊥) of the liquid crystal layer 300 is greater than 8, the driving voltage for liquid crystal can increase.

Moreover, when the overall average vertical permittivity (ε⊥) of the liquid crystal layer 300 becomes less than 3 or greater than 8, it can be difficult to set the overall average horizontal permittivity (ε//) of the liquid crystal layer 300 for setting the overall average dielectric anisotropy (Δε) of the liquid crystal layer 300 within the range of greater than 2 and less than 20.

As described above, according to the present invention, by using the liquid crystal layer 300 including the positive liquid crystal 310 and the negative liquid crystal 320, a light transmittance can be enhanced. Also, by increasing the overall average horizontal permittivity (ε//) of the liquid crystal layer in proportion to an increase in the overall average vertical permittivity (ε⊥) of the liquid crystal layer, a decrease in the overall average dielectric anisotropy (Δε) of the liquid crystal layer is prevented, thus preventing the driving voltage for the liquid crystal from increasing.

Moreover, according to the present invention, the overall average vertical permittivity (ε⊥) and average horizontal permittivity (ε//) of the liquid crystal layer increase, and thus, an electric field between the first electrode 240 and the second electrode 280 is strengthened in each of cells.

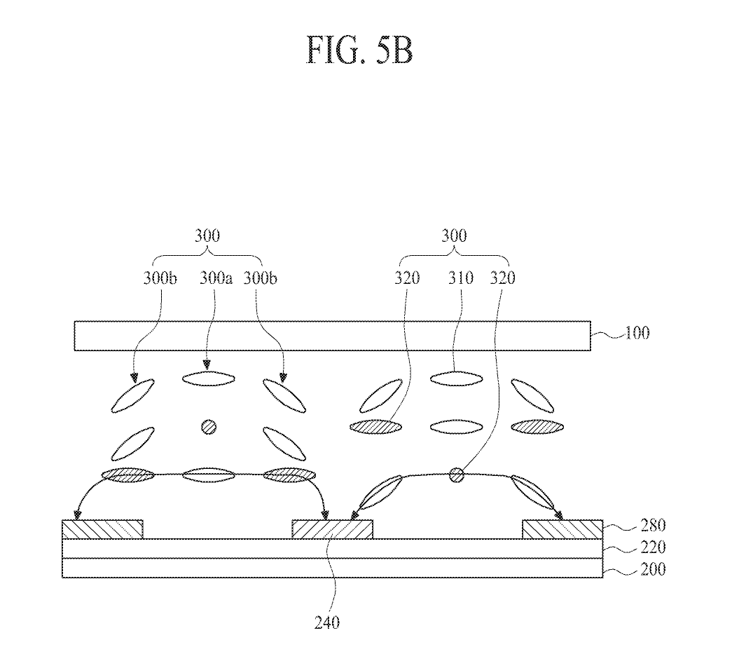

FIGS. 5A and 5B are sectional views schematically illustrating an LCD device in an IPS mode according to various embodiments.

As seen in FIGS. 5A and 5B, the LCD device according to various embodiments includes a first substrate 100, a second substrate 200, and a liquid crystal layer 300.

A configuration of the first substrate 100 and a configuration of the liquid crystal layer 300 are the same as the above-described LCD device of FIG. 2. Hereinafter, therefore, only a configuration of the second substrate 200 will be described.

An array layer 220, a first electrode 240, and a second electrode 280 are formed on the second substrate 200.

The array layer 220 is as described above, and thus, its detailed description is not provided.

A plurality of the first electrodes 240 and second electrodes 280 are alternately arranged in parallel, and thus, a lateral electric field is generated between the first and second electrodes 240 and 280.

The first and second electrodes 240 and 280, as illustrated in FIG. 5A, may be formed on different layers with the insulating layer 260 therebetween, or, as illustrated in FIG. 5B, the first and second electrodes 240 and 280 may be formed on the same layer,

One of the first and second electrodes 240 and 280 may be a pixel electrode connected to a TFT of the array layer 220, and the other may be a common electrode.

Although not shown, the pixel electrode may be formed to directly contact a drain electrode of the array layer 200 without passing through a certain contact hole. Also, the common electrode may he formed on the same layer as a gate line of the array layer 220.

The above description has been made of embodiments of the LCD device, and the LCD device is not limited to only the above-described structure. As another example, the LCD device may have a structure in which the pixel electrodes and the common electrodes are formed on the second substrate 200, and for example, have various IPS structures or FFS structures known to those skilled in the art.

According to one embodiment, by using the liquid crystal layer in which the negative liquid crystal is added to the positive liquid crystal, the percentage of liquid crystals whose director is tilted is reduced, thus increasing light transmittance.

Moreover, according to one embodiment, by increasing the overall average horizontal permittivity (ε//) of the liquid crystal layer in proportion to an increase in the overall average vertical permittivity (ε⊥) of the liquid crystal layer, a decrease in the overall average dielectric anisotropy (Δε) of the liquid crystal layer is prevented, thus preventing the driving voltage for the liquid crystal from increasing.

Moreover, according to an embodiment of the present invention, the overall average vertical permittivity (ε⊥) and average horizontal permittivity (c of the liquid crystal layer increase, and thus, the electric fields between the pixel electrodes and the common electrodes are strengthened in the respective cells.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed I:

1. A liquid crystal display (LCD) device, comprising:
first and second substrates facing each other;
a liquid crystal layer formed between the first and second substrates; and
first and second electrodes formed on the second substrate, the first and second electrodes generating an electric field for adjusting alignment of liquid crystals of the liquid crystal layer,
wherein the liquid crystal layer is firmed by combination of a positive liquid crystal whose dielectric anisotropy (Δε) has a positive (+) value and a negative liquid crystal whose dielectric anisotropy (Δε) has a negative (−) value.

2. The LCD device of claim 1, wherein the negative liquid crystal overall occupies 50 weight % or less of the liquid crystal layer.

3. The LCD device of claim 1, wherein the negative liquid crystal overall occupies 5 weight % or more of the liquid crystal layer.

4. The LCD device of claim 1, wherein average dielectric anisotropy of the liquid crystal layer is greater than 2 and less than 20.

5. The LCD device of claim 1, wherein an average horizontal permittivity (ε//) of the liquid crystal layer is not less than 3 and not more than 8.

6. The LCD device of claim 1, wherein the first electrode and second electrode are alternately arranged in parallel, and a lateral electric field is generated between the first and second electrodes.

7. The LCD device of claim 1, wherein one of the first and second electrodes is formed in a plate shape, and the other is formed in a finger shape, thereby generating a fringe field between the first and second electrodes.

8. A liquid crystal display (LCD) device, comprising:
first and second substrates facing each other;
a liquid crystal layer formed between the first and second substrates; and
first and second electrodes formed on the second substrate, the first and second electrodes generating an electric field for adjusting alignment of liquid crystals of the liquid crystal layer,
wherein the liquid crystal layer is formed by combination of a first liquid crystal and a second liquid crystal, wherein a director of the first liquid crystal is tilted and a director of the second liquid crystal is not tilted at a certain angle with respect to a horizontal surface of a substrate when the electric field is applied thereto.
